(19) United States
(12) Patent Application Publication
(10) Pub. No.: US 2026/0341605 A1
(43) Pub. Date: Oct. 29, 2026

(54) SYSTEM FOR ACTUATING A TAP CHANGER

(71) Applicant: Maschinenfabrik Reinhausen GmbH, Regensburg (DE)

(72) Inventors: Michael HEGER, Straubing (DE); Udo HERTEL, Regensburg (DE)

(21) Appl. No.: 19/110,820

(22) PCT Filed: Jul. 31, 2023
(86) PCT No.: PCT/EP2023/071136

§ 371 Date: Mar. 12, 2025

(30) Foreign Application Priority Data
Sep. 15, 2022 (DE) 10 2022 123 571.8

(51) Int. Cl. H01H 9/00

(52) U.S. Cl. CPC H01H 9/0027

(57) ABSTRACT

A system for actuating at least one tap changer, including a tap changer for switching between winding taps of a control winding of a transformer, wherein the tap changer has a position transmitter for detecting a current position of the tap changer, a driver, which has a motor and a gear unit, and a controller, which has an external signal interface. The driver further includes a motor controller and a motor driver. The motor controller is configured to receive the current position of the tap changer from the position transmitter and actuate the motor such that the tap changer is switched from a first winding tap to a new winding tap. The controller is configured to actuate the motor controller.

### CROSS REFERENCE TO RELATED APPLICATIONS

This application is a U.S. National Phase application under 35 U.S.C. § 371 of International Application No. PCT/EP2023/071136, filed on Jul. 31, 2023, and claims benefit to German Patent Application No. DE 10 2022 123 571.8, filed on Sep. 15, 2022. The International Application was published in German on Mar. 21, 2024 as WO 2024/056265 A1 under PCT Article 21(2).

### FIELD

The invention relates to a system for actuating at least one tap changer.

### BACKGROUND

Tap changers, in particular on-load tap changers, are used for uninterrupted switching between winding taps of a transformer. Known on-load tap changers consist, for example, of a selector for power-free preselection of the respective winding tap to which a switchover is intended to be made, and a diverter switch for the actual load switchover from the previous winding tap to the new, preselected winding tap. For switching over or actuating the corresponding components, known tap changers have a motor drive, which is usually arranged on the tap changer head on the transformer cover. The motor controller together with a motor driver is generally accommodated in a control cabinet that is connected to the motor drive via a cable line. Since the cable length is limited, it is necessary to arrange the control cabinet in close proximity to the transformer. As a rule, the control cabinet is therefore mounted directly on the transformer housing. The control cabinet also forms the interface to the user or the power network operator and has corresponding input and output terminals for signal transmission.

The disadvantage of this solution is that, owing to the limited cable length, the control cabinet is arranged in close proximity to the transformer and therefore in a hazardous area for the operator. A further disadvantage is that the equipment and the devices that are required for measurement and open-loop and closed-loop control technology of networks and require signals from the controller are located away from the transformer, for example in an operating building of the substation or a control room, and therefore there is a high cabling requirement from the transformer to the operating building or control room. In addition, the installation of the control cabinet itself and the setup of the corresponding signal interfaces are associated with a high degree of complexity.

### SUMMARY

In an embodiment, the present disclosure provides a system for actuating at least one tap changer, comprising a tap changer for switching between winding taps of a control winding of a transformer, wherein the tap changer has a position transmitter for detecting a current position of the tap changer, a driver, which has a motor and a gear unit, and a controller, which has an external signal interface. The driver further comprises a motor controller and a motor driver. The motor controller is configured to receive the current position of the tap changer from the position transmitter and actuate the motor such that the tap changer is switched from a first winding tap to a new winding tap. The controller is configured to actuate the motor controller.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of an embodiment of a system according to the present disclosure;

FIG. 2 shows a further schematic illustration of the system from FIG. 1;

FIG. 3 shows a schematic illustration of an embodiment of the system according to the present disclosure;

FIG. 4 shows a schematic illustration of an embodiment of the system according to the present disclosure; and

FIG. 5 shows a schematic illustration of an embodiment of the system according to the present disclosure.

### DETAILED DESCRIPTION

In an embodiment, the present disclosure provides an improved system for actuating a tap changer, which system is compact and safe, allows easy assembly and at the same time is cost-effective.

The improvement is based on moving the components relevant for actuating the tap changer to where they are needed. In other words, the improvement integrates the electronic motor controller together with the motor driver and, if present, an energy accumulator together with the motor and the gear unit directly into the drive unit on the tap changer head, and moving the signal interfaces for the operator to the operating building of the substation, where the devices of the network control system are located. In this way, the control cabinet on the transformer can be completely dispensed with and the cabling requirement can be reduced.

The present disclosure specifies a system for actuating at least one tap changer, which system comprises a tap changer for switching between winding taps of a control winding of a transformer, wherein the tap changer has a position transmitter for detecting the current position of the tap changer. In other words, the position transmitter indicates which winding tap of the control winding the tap changer is currently located on. The system further comprises a drive unit, which has a motor and a gear unit, and also a control unit, which has at least one external signal interface.

The external signal interface is used to input and output operator signals or the signals of the network control system.

The motor is designed, for example, as a servo motor, DC motor or brushless DC motor.

The drive unit further comprises a motor controller and a motor driver. The motor controller is designed to receive the current position of the tap changer from the position transmitter and actuate the motor in such a way that the tap changer is switched from one winding tap to a new winding tap.

The control unit is designed to actuate the motor controller. The actuation is performed, for example, depending on a voltage regulator, which monitors the network voltage and keeps it within a defined target range via switching commands to the tap changer or the control unit. As an alternative, the control unit can also be controlled by a superordinate control facility, for example a control room.

Owing to the motor controller and motor driver being moved into the drive unit of the tap changer, the entire drive functionality is spatially placed directly on the tap changer, which makes the design of the system for actuating the tap changer more compact and reduces the cabling requirement and installation effort. The space required on site at the transformer is also reduced since the control cabinet is no longer required. The control unit with the external interfaces to the network control system or the operator does not necessarily have to be arranged close to the transformer, which gives the operator more freedom in selecting the location of the control unit and provides the additional advantage that access to the controller of the system is no longer in the hazardous area for the operator.

The motor controller is preferably designed as an electronic controller, in particular as a programmable logic controller.

According to an embodiment, the tap changer has a tap changer head, by means of which the tap changer can be fixed to a housing of the transformer, wherein the drive unit is located directly on the tap changer head. The tap changer head can be designed, for example, as a flange and located on the transformer cover.

According to an embodiment, the control unit is arranged spatially separated from the tap changer and the transformer, in particular in an operating building of a substation and/or a control room.

According to an embodiment, the system comprises a first line for internal communication between the drive unit and the control unit. In other words, the first line is designed as a communication line. For this purpose, the drive unit and the control unit each have a communication interface. The communication interface is used to transmit the tap changer signals, which are detected by corresponding sensors in the tap changer and transmitted via the first line from the drive unit to the control unit, and also to control the tap changer. The sensors, for example an end position sensor, which indicates when the tap changer is in an end position, a temperature sensor, which measures the temperature in the tap changer, a humidity sensor, which measures the humidity of the insulating oil in the tap changer, or a current sensor, which measures the load current of the tap changer, transmit the corresponding measured values to the drive unit, in particular the motor controller of the drive unit. The measured values are digitized there and further transmitted to the control unit. The current position of the tap changer, which is detected by the position transmitter, is also transmitted via the first line.

According to an embodiment, a bus system is used for internal communication. The advantages of using a bus system are the possibility of data exchange or communication between several elements of the system and also the large spatial distance that is made possible between the elements via a bus system. A further advantage of using a bus system is the standardized communication protocols that are used for communication.

According to an embodiment, the system comprises a second line for supplying power to the drive unit.

According to an embodiment, the first and the second line are designed as a common line. In other words, the first and the second line can also be configured as a hybrid line.

The system therefore comprises a maximum of two lines between the drive unit on the transformer and the control unit, which lines are used for communication and power supply. The cabling complexity is therefore reduced to a possible minimum.

According to an embodiment, the drive unit comprises an electrical energy accumulator. In particular, the energy accumulator ensures that, even in the event of a fault, for example a power failure or a breakdown in communication, an initiated switchover of the tap changer is completed.

According to an embodiment, the electrical energy accumulator is designed as a capacitor or as a battery.

According to an embodiment, the tap changer comprises a mechanical spring energy accumulator. An output shaft driven by the motor at a constant speed preloads a storage spring up to a maximum point. When this maximum point is exceeded, the accumulator spring suddenly relaxes and in so doing abruptly drives a drive shaft, which in turn actuates the corresponding contacts to switch the tap changer to the new position.

According to an embodiment, the system comprises a spring energy accumulator and/or an energy accumulator.

According to an embodiment, the control unit comprises an input unit. The input unit can be designed in any desired way for the input of data into the control unit. By way of example, the input unit can be designed as a local operator control unit on the control unit and can have a rotary wheel arranged on the control unit, keys, a connection for external storage media, for example a connection for a USB stick or an SD card, or a touchscreen or combinations thereof. Similarly, the input unit can be designed as a mobile terminal, for example as a tablet or smartphone, and can be connected wirelessly to the control unit.

The control unit and the input unit can each be designed as separate units or as a common structural unit.

According to an embodiment, the control unit comprises an output unit for outputting data and signals relating to the system. The output can be performed in any desired way, for example displayed on a screen or as digital or analog signals for further processing in an adjacent or superordinate system, for example the operator system.

The control unit and the output unit can each be designed as separate units or as a common structural unit.

According to an embodiment, the input unit and the output unit are designed as separate units or as a common unit.

According to an embodiment, the control unit, the input unit and the output unit are designed as a common unit.

According to an embodiment, the control unit can be dispensed with and the drive unit can be directly controlled by an adjacent or superordinate system, for example the operator system. In this case, the operator system replicates the functionality of the control unit.

According to an embodiment, the system comprises at least one second tap changer for switching between winding taps of a control winding of a transformer, wherein the at least one second tap changer has a second position transmitter for detecting the current position of the at least one second tap changer. Furthermore, the system comprises at least one second drive unit, which has a second motor and a second gear unit and is assigned to the at least one second tap changer, wherein the at least one second drive unit further comprises a second motor controller and a second motor driver, wherein the second motor controller is designed to receive the current position of the at least one second tap changer from the second position transmitter and actuate the second motor in such a way that the at least one second tap changer is switched from one winding tap to a new winding tap. The control unit is designed to actuate each motor controller of the system.

The motor controllers of the system can be actuated individually or together or in parallel. Depending on the application, the second tap changer can be assigned to a second transformer or to the same transformer as the first tap changer. The motor controllers are actuated separately in phase shift applications, for example. The motor controllers are actuated together or in parallel when several single-phase or three-phase transformers are running in parallel, for example. In this case, each transformer has a tap changer assigned to it.

According to an embodiment, the system comprises a first, a second and a third tap changer for switching between winding taps of a control winding of at least one transformer, wherein each tap changer has a position transmitter for detecting the current position of the respective tap changer. The system according to this embodiment further comprises a first, a second and a third drive unit, each of which has a motor and a gear unit and is assigned to a respective one of the three tap changers, wherein each drive unit further comprises a motor controller and a motor driver, wherein each motor controller is designed to receive the current position of the respective assigned tap changer from the respective position transmitter and actuate the respective motor in such a way that the respective assigned tap changer is switched from one winding tap to a new winding tap. The system comprises a control unit, which is designed to actuate each motor controller of the system separately or together or in parallel.

According to an embodiment, the system comprises a first, a second and a third tap changer for switching between winding taps of a control winding of at least one transformer, wherein each tap changer has a position transmitter for detecting the current position of the respective tap changer. The system according to this embodiment further comprises a first, a second and a third drive unit, each of which has a motor and a gear unit and is assigned to a respective one of the three tap changers, wherein each drive unit further comprises a motor controller and a motor driver, wherein each motor controller is designed to receive the current position of the respective assigned tap changer from the respective position transmitter and actuate the respective motor in such a way that the respective assigned tap changer is switched from one winding tap to a new winding tap. According to this embodiment, one of the three motor controllers is defined as a master and designed to actuate the two other motor controllers, which are designed as slaves, together or separately. The system comprises a control unit, which is designed to control the drive unit of the system defined as the master and indirectly actuate the two other drive units, which are designed as slaves, via this drive unit. Consequently, the control unit is designed to actuate each motor controller of the system directly or indirectly, separately or together or in parallel.

Further embodiments and implementations of the system are directly evident from the various embodiments of the system.

Embodiments of the present disclosure are explained below in detail on the basis of exemplary embodiments with reference to the drawings. Components that are identical or functionally identical or have an identical effect can be provided with identical reference signs. Identical components or components with an identical function are in some cases explained only in relation to the figure in which they first appear.

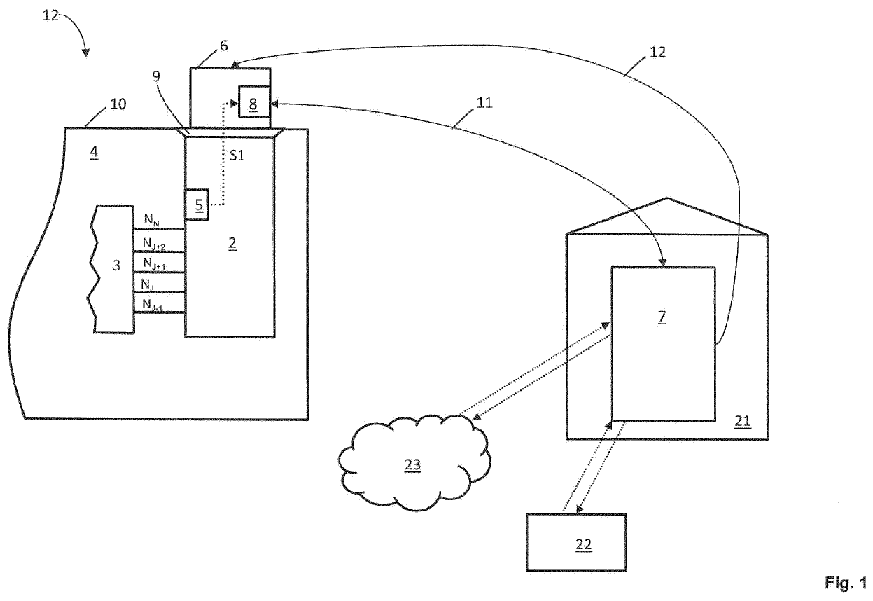

FIG. 1 shows a schematic illustration of a first embodiment of a system 1 according to the present disclosure.

The system 1 comprises a tap changer 2 for switching between winding taps N_{J}, N_{J+1}, N_{J+2}, . . . , N_{N} of a control winding 3 of a transformer 4. The transformer 4 is, for example, a power transformer, which is located in a substation. For the switchover, the tap changer 2 has, for example, a selector for power-free preselection of the respective winding tap N_{N} to which a switchover is intended to be made, and a diverter switch for the actual load switchover from the previous winding tap N_{J} to the new, preselected winding tap N_{J+1}. The tap changer 2 is fastened by means of a tap changer head 9 to a housing 10 of the transformer 4, in particular to the transformer cover. The tap changer head 9 is designed, for example, as a flange. A drive module 6 is arranged directly on the tap changer head 9.

The tap changer 2 further comprises a position transmitter 5, which is designed to specify the current position of the tap changer 2, i.e. that winding tap N_{J}, N_{J+1}, N_{J+2}, . . . , N_{N} on which the tap changer 2 is currently located, and transmit it in the form of an analog or digital signal to a motor controller 8 via a signal connection S1. The S1 signal can be transmitted via a cable or else wirelessly, for example via radio. The motor controller 8 is arranged in the drive unit 6 and designed as a programmable logic controller.

The system 1 also comprises a control unit 7, which is designed to control the motor controller 8. For this purpose, a first line 11, which is designed as a BUS communication line, is provided from the control unit 7 to the drive unit 6. The drive unit 6 or the motor controller 8 is actuated depending on a voltage regulator 22 or a superordinate control facility 23, such as a control room for example. The drive unit 6 is supplied with power via a second line 12. The control unit 7 is accommodated in an operating building 21, where the devices of the network control system are generally also located.

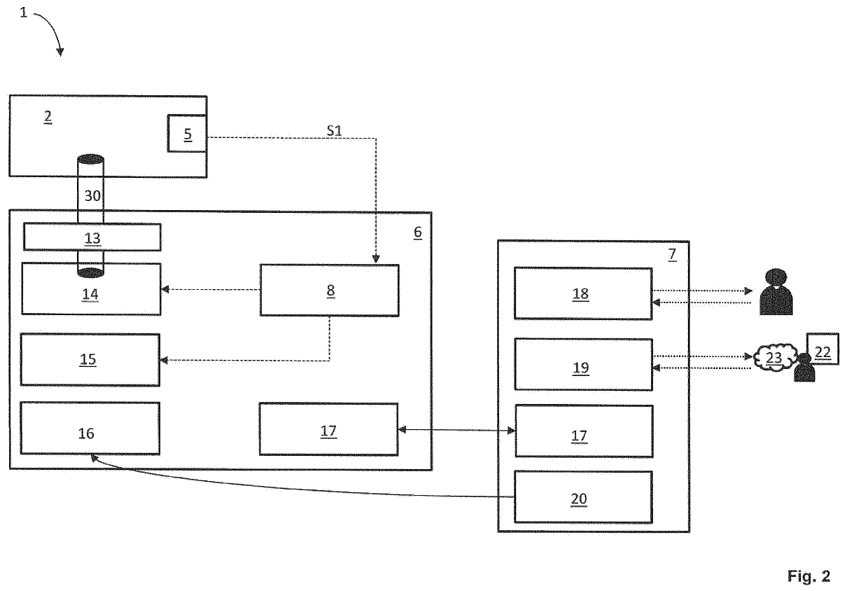

FIG. 2 shows the system from FIG. 1 in a further, schematic illustration, wherein here in particular the drive unit 6 and the control unit 7 are illustrated in detail. With regard to the system 1 from FIG. 2, reference is made to the preceding explanations relating to the system 1 from FIG. 1 in an analogous manner and only the differences and supplementary features are discussed in the following.

The drive unit 6 included in the system 1 accordingly comprises a motor 14, which actuates the tap changer 2, in particular the selector and the diverter switch, via a drive shaft 30 and a gear unit 13, and also a motor driver 15 and an energy accumulator 16. The motor controller 8 is designed to tap off the current position of the tap changer 2 from the position transmitter 5 and actuate the motor 14 and also the motor driver 15. In addition, the drive unit 6 has an internal communication interface 17, which is designed as a BUS communication interface and via which communication with the control unit 7 is implemented.

The control unit 7 accordingly also comprises an internal communication interface 17, which is designed as a BUS communication interface and via which communication with the drive unit 6 takes place. The energy accumulator 16 of the drive unit 6 is supplied with energy via a power supply device 20. The control unit 7 further has an input unit 18, which is also designed as an output unit 18 and via which an operator of the system 1 can manually operate the control unit 18 and read out data. The input and output unit 18 is designed as a touchscreen, for example. In addition, the control unit 7 comprises an external signal interface 19, which serves for the electrical input and output of operator signals or the signals of the network control system. For example, switching signals are input from the voltage regulator 22 and/or the superordinate control facility 23 or control room, and/or analog and/or digital signals are output from the sensors of the tap changer 2 via the external signal interface 19.

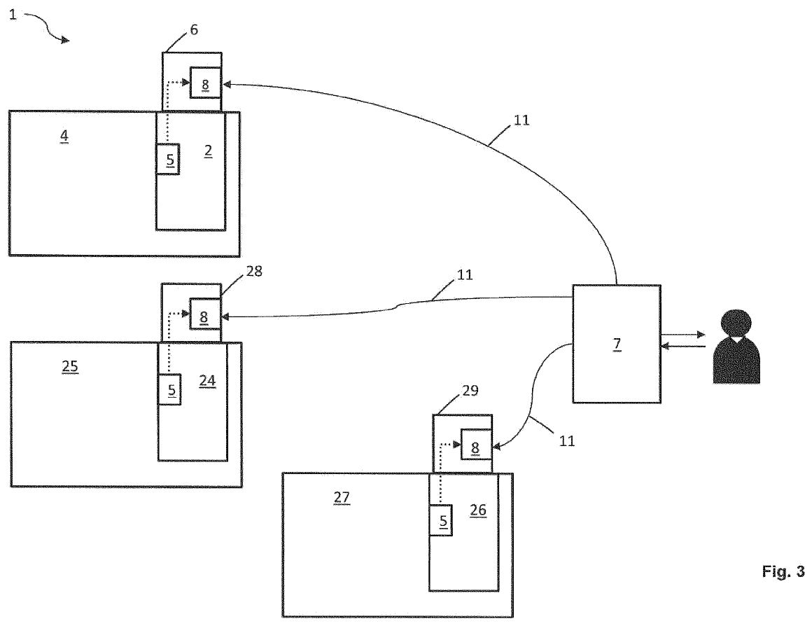

FIG. 3 shows a schematic illustration of a second embodiment of the system according to the present disclosure. FIG. 3 shows a possible application of the system 1, wherein the system 1 comprises several tap changers and several transformers. With regard to the system 1 from FIG. 3, reference is made to the preceding explanations relating to the system 1 from FIGS. 1 and 2 in an analogous manner and only the differences and supplementary features are discussed in the following.

According to this embodiment, the system 1 comprises, in addition to a first tap changer 2 for switching between winding taps of a control winding (FIG. 1) of a first transformer 4, a second tap changer 24 for switching between winding taps of a control winding of a second transformer 25 and a third tap changer 26 for switching between winding taps of a control winding of a third transformer 27. Each tap changer 2, 24, 26 has a position transmitter 5 for detecting the current position of the respective tap changer 2, 24, 26. The system 1 further comprises a first drive unit 6, which is assigned to the first tap changer 2, a second drive unit 28, which is assigned to the second tap changer 24, and a third drive unit 29, which is assigned to the third tap changer 26. Each drive unit 6, 28, 29 further comprises a motor controller 8 and a motor driver 15 (FIG. 2). Each motor controller 8 is designed to receive the current position of the respective tap changer 2, 24, 26 from the respective position transmitter 5 and actuate the respective motor 14 (FIG. 2) in such a way that the respective tap changer 2, 24, 26 switches over. The system 1 further comprises a control unit 7, which is designed to actuate each motor controller 8 of the three drive units 6, 28 and 29. For this purpose, the control unit 7 is connected to the drive units 6, 28, 29 via communication lines 11. Depending on the particular application, the actuation can be performed separately or together or in parallel. In this case, the number of transformers 4, 25, 27 and also the tap changers 2, 24, 27 assigned to them, together with drive units 6, 28, 29 in the system 1, is not limited to the specified number three or another number.

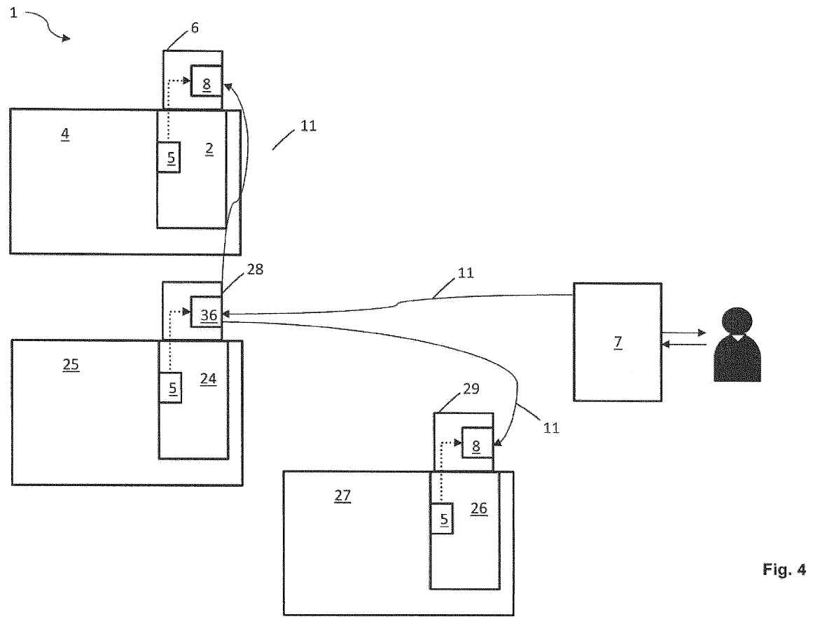

FIG. 4 shows a schematic illustration of a third embodiment of the system according to the present disclosure. FIG. 4 shows a further, possible application of the system 1, wherein the system 1 comprises several tap changers and several transformers. With regard to the system 1 from FIG. 4, reference is made to the preceding explanations relating to the system 1 from FIGS. 1 to 3 in an analogous manner and only the differences and supplementary features are discussed in the following.

The difference between this third embodiment and the second embodiment described in FIG. 3 is that one of the three motor controllers is defined as the master, specifically the master motor controller 36, which actuates the tap changer 24. The master motor controller 36 is designed to actuate the two other motor controllers 8, which in this case are designed as slaves and assigned to the tap changers 2 and 26, together or separately. The system 1 also comprises a control unit 7, which is designed to control the master motor controller 36 and the second drive unit 28 of the system 1, which are assigned to the tap changer 24, and indirectly actuate the two other motor controllers 8 or the drive units 6 and 29, which are designed as slaves, via this control unit. Consequently, the control unit 1 is designed to actuate each motor controller 8, 36 and thus each tap changer 2, 24, 26 of the system 1 directly or indirectly, separately or together or in parallel.

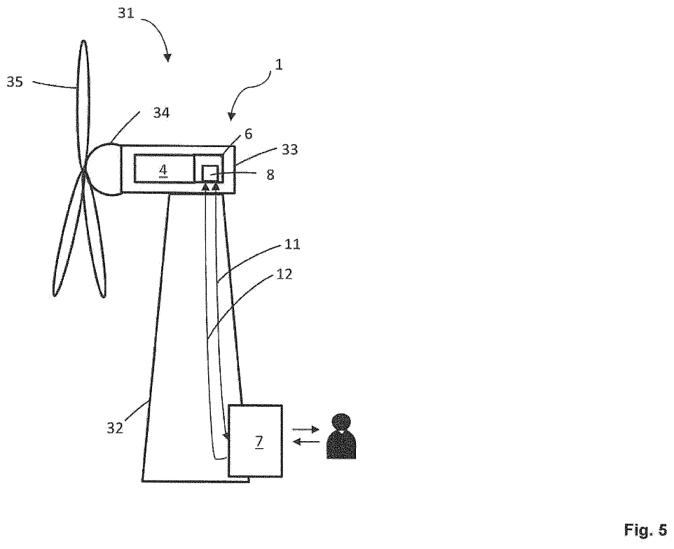

FIG. 5 shows a schematic illustration of a fourth embodiment of the system according to the present disclosure. FIG. 5 shows a possible application of the system 1 in a wind turbine 31. With regard to the system 1 from FIG. 5, reference is made to the preceding explanations relating to the system 1 from FIGS. 1 to 4 in an analogous manner and only the differences and supplementary features are discussed in the following.

Wind turbines produce electrical energy with a voltage of up to 1000 volts. This voltage is then transformed to medium voltage (10 to 30 kV) by transformers depending on the local network voltage. The wind turbine 31 according to FIG. 5 comprises a tower 32, on which a nacelle 33 and a hub 34 with three rotor blades 35 are located. The nacelle 33 contains the components required to convert the rotor rotation into electrical energy, including a gear unit and a generator. According to this embodiment, the controllable transformer 4 of the system 1 is also located in the nacelle 33. In other words, a transformer 4 is arranged in the nacelle 33, which transformer comprises a tap changer 2 according to the present disclosure. In addition, the drive unit 6 included in the system 1 and having the motor controller 8 is also arranged in the nacelle 33. The control unit 7 of the system 1 is arranged at the foot of the tower 32 such that it is within easy reach of the operator. Two cables 11 and 12 ensure communication and power supply between the control unit 7 and the drive unit 6 in the nacelle 33. Even in this embodiment or application of the system 1, the possibility of flexible spatial arrangement of the components for actuating the tap changer, the simple design owing to the omission of the control cabinet and the low cabling requirement are considerably advantageous for the operator of the wind turbine.

In summary, the present disclosure specifies a system for actuating a tap changer that allows an extremely compact design directly on the transformer, saves costs owing to the omission of the control cabinet on the transformer, is of simple design, in particular owing to the minimized cable requirement, which is made possible by a BUS communication system, and also offers a high degree of flexibility in terms of the range of applications.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 System
2 Tap changer
3 Control winding
4 Transformer
5 Position transmitter
6 Drive unit
7 Control unit
8 Motor controller
9 Tap changer head
10 Housing of 4
11 First line
12 Second line
13 Gear unit
14 Motor
15 Motor driver
16 Energy accumulator
17 Communication interface
18 Input and output unit
19 Signal interface
20 Power supply
21 Operating building
22 Voltage regulator
23 Superordinate control facility, control room
24 Second tap changer
25 Second transformer
26 Third tap changer
27 Third transformer
28 Second drive unit
29 Third drive unit
30 Drive shaft
31 Wind turbine
32 Tower
33 Nacelle
34 Hub
35 Rotor blade
36 Master motor controller
N_{J}, N_{J+1}, . . . N_{N} Winding taps
S1 Signal

1. A system for actuating at least one tap changer, comprising:
a tap changer for switching between winding taps of a control winding of a transformer, wherein the tap changer has a position transmitter for detecting a current position of the tap changer;
a driver with a motor and a gear unit; and
a controller with an external signal interface, wherein:
the driver further comprises a motor controller and a motor driver, wherein the motor controller is configured to receive the current position of the tap changer from the position transmitter and actuate the motor such that the tap changer is switched from a first winding tap to a new winding tap, and
the controller is configured to actuate the motor controller.

2. The system as claimed in claim 1, wherein:
the tap changer has a tap changer head by which the tap changer is configured to be fixed to a housing of the transformer, and
the driver is located directly on the tap changer head.

3. The system as claimed in claim 1, wherein the controller is arranged spatially separated from the tap changer and the transformer in an operating building of a substation and/or a control room.

4. The system as claimed in claim 1, wherein the system comprises a first line configured for internal communication between the driver and the controller.

5. The system as claimed in claim 4, comprising a bus system is configured to provide for the internal communication.

6. The system as claimed in claim 1, further comprising a second line configured to supply power to the driver.

7. The system as claimed in claim 1, wherein the driver further comprises an energy accumulator.

8. The system as claimed in claim 1, comprising:
at least one second tap changer for switching between winding taps of a control winding of a second transformer, wherein the at least one second tap changer has a position transmitter for detecting a current position of the at least one second tap changer; and
at least one second driver with a motor and a gear unit, the at least one second driver being assigned to the second tap changer wherein:
the at least one second driver further comprises a motor controller and a motor driver, the motor controller being configured to receive the current position of the at least one second tap changer from the position transmitter of the at least one second tap changer and actuate the motor of the at least one second driver such that the at least one second tap changer is switched from a first winding tap of the control winding of the second transformer to a new winding tap of the control winding of the second transformer, and
the controller is configured to actuate each motor controller of the system.
